(19) United States
(12) Patent Application Publication
(10) Pub. No.: US 2019/0019078 A1
(43) Pub. Date: Jan. 17, 2019

(54) APPARATUS AND METHOD FOR DISTRIBUTING A QUESTION

(71) Applicant: MINDS LAB., INC., Daejeon (KR)

(72) Inventors: Yi Gyu HWANG, Gyeonggi-do (KR); Kang Woo PARK, Gyeongsangnam-do (KR); Dong Hyun YOO, Seoul (KR); Su Lyn HONG, Seoul (KR); Tae Joon YOO, Incheon (KR)

(73) Assignee: MINDS LAB., INC., Daejeon (KR)

(21) Appl. No.: 16/034,327

(22) Filed: Jul. 12, 2018

(30) Foreign Application Priority Data
Jul. 12, 2017 (KR) 10-2017-0088370

(51) Int. Cl. G06N 3/00; G06N 3/04; G06N 3/08; G06F 17/27

(52) U.S. Cl. CPC G06N 3/006; G06F 17/2785; G06N 3/088; G06N 3/0427

(57) ABSTRACT

The present disclosure relates to an apparatus and method of allocating a question according to a question type or question feature. A question allocating apparatus for the same may include a question analysis unit generating at least one of question type information and question feature information of a current question; and a question allocating unit determining an answer generating unit suitable for the current questions among a plurality of answer generating units based on at least one of the question type information, and the question feature information, and allocating the current question to at least one answer generating including the determined answer generating unit.

### CROSS REFERENCE TO RELATED APPLICATION

The present application claims priority to Korean Patent Application No. 10-2017-0088370, filed Jul. 12, 2017, the entire contents of which is incorporated herein for all purposes by this reference.

### BACKGROUND OF THE INVENTION

### Field of the Invention

The present disclosure relates generally to an apparatus and method of allocating a question according to a question type or a question feature.

### Description of the Related Art

A Question and answering technique means technique of analyzing a user's question, and providing to the user an answer corresponding to a purpose of the question. However, in conventional question and answering technique, a single question and answer (QA) engine is generally used for implementing the same, and thus questions are answered in a limited range. For example, when a question and answering system is implemented on the basis of a database such as encyclopedia, Wikipedia, a language dictionary, etc., an answer suitable for a technical professional may be provided, but an answer suitable for a layperson user can not be provided.

Accordingly, a question and answering system capable of covering wide range may be considered by diversifying QA engines.

### SUMMARY OF THE INVENTION

An object of the present disclosure is to provide an apparatus and method of allocating a question to an engine that is suitable for generating an answer to the question.

Another object of the present disclosure is to provide an apparatus and method of analyzing a type and a feature of a question before allocating the question.

Still another object of the present disclosure is to provide an apparatus and method of allocating a question in consideration of priorities among engines.

Technical problems obtainable from the present disclosure are not limited by the above-mentioned technical problems, and other unmentioned technical problems may be clearly understood from the following description by those having ordinary skill in the technical field to which the present disclosure pertains

In a question allocating apparatus and a question allocating method according to one aspect of the present disclosure, at least one of question type information and question feature information of a current question may be generated, an answer generating unit suitable for generating an answer to the current question may be determined from a plurality of answer generating units on the basis of at least one of the question type information and the question information, and the current question may be allocated to at least one answer generating unit including the determined answer generating unit.

In a question allocating apparatus and a question allocating method according to one aspect of the present disclosure, the answer generating unit may operate on the basis of a plurality of QA engines, and a QA engine used for generating the answer to the current question may be determined on the basis of priorities among the plurality of QA engines.

In a question allocating apparatus and a question allocating method according to one aspect of the present disclosure, when the answer to the current question is not generated by using a QA engine having an N-th priority, the answer generating unit may generate the answer to the current question by using a QA engine having an N+1-th priority.

In a question allocating apparatus and a question allocating method according to one aspect of the present disclosure, when a plurality of answers for the current question is generated, an answer to be output may be selected on the basis of priorities among the plurality of answer generating units.

In a question allocating apparatus and a question allocating method according to one aspect of the present disclosure, determining of the answer generating unit may be performed in consideration of at least one of user profile information and previous conversation record data.

In a question allocating apparatus and a question allocating method according to one aspect of the present disclosure, the previous conversation record data may include a question input previous than the current question, and determining of the answer generating unit may be performed by referencing at least one of question type information and question feature information of the previous question.

In a question allocating apparatus and a question allocating method according to one aspect of the present disclosure, the question type information may include information of at least one of a domain to which the current question belongs, an answer type of the current question, a discourse type of the current question, and an emotional tone of the current question.

In a question allocating apparatus and a question allocating method according to one aspect of the present disclosure, the question feature information may be generated on the basis of at least one of a time, a space, a position, and a named entity included in the current question.

It is to be understood that the foregoing summarized features are exemplary aspects of the following detailed description of the present disclosure without limiting the scope of the present disclosure.

According to the present disclosure, reliability of an answer can be improved by allocating a question to an engine suitable for generating the answer to the question.

According to the present disclosure, a type and a feature of a question can be effectively analyzed before selecting an engine suitable for the question.

According to the present disclosure, a question can be allocated in consideration of priorities among engines.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a view showing a question allocating apparatus according to an embodiment of the present disclosure;

FIG. 2 is a view showing an exemplary configuration of a plurality of answer generating units; and

FIG. 3 is a view of a flowchart showing question analysis and question allocating according to the present disclosure.

### DETAILED DESCRIPTION OF THE INVENTION

As embodiments allow for various changes and numerous embodiments, exemplary embodiments will be illustrated in the drawings and described in detail in the written description. However, this is not intended to limit embodiments to particular modes of practice, and it is to be appreciated that all changes, equivalents, and substitutes that do not depart from the spirit and technical scope of embodiments are encompassed in embodiments. The similar reference numerals refer to the same or similar functions in various aspects. The shapes, sizes, etc. of components in the drawings may be exaggerated to make the description clearer. In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a certain feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present disclosure is defined only by the appended claims, appropriately interpreted, along with the full range of equivalents to which the claims are entitled.

It will be understood that, although the terms including ordinal numbers such as “first”, “second”, etc. may be used herein to describe various elements, these elements are not limited by these terms. These terms are only used to distinguish one element from another. For example, a second element could be termed a first element without departing from the teachings of the present inventive concept, and similarly a first element could be also termed a second element. The term “and/or” includes any and all combination of one or more of the associated items listed.

When an element is referred to as being “connected to” or “coupled with” another element, it can not only be directly connected or coupled to the other element, but also it can be understood that intervening elements may be present. In contrast, when an element is referred to as being “directly connected to” or “directly coupled with” another element, there are no intervening elements present.

Also, components in embodiments of the present disclosure are shown as independent to illustrate different characteristic functions, and each component may be configured in a separate hardware unit or one software unit, or combination thereof. For example, each component may be implemented by combining at least one of a communication unit for data communication, a memory storing data, and a control unit (or processor) for processing data.

Alternatively, constituting units in the embodiments of the present disclosure are illustrated independently to describe characteristic functions different from each other and thus do not indicate that each constituting unit comprises separate units of hardware or software. In other words, each constituting unit is described as such for the convenience of description, thus at least two constituting units may form a single unit and at the same time, a single unit may provide an intended function while it is divided into multiple sub-units, and an integrated embodiment of individual units and embodiments performed by sub-units all should be understood to belong to the claims of the present disclosure as long as those embodiments belong to the technical scope of the present disclosure.

Terms are used herein only to describe particular embodiments and do not intend to limit the present disclosure. Singular expressions, unless contextually otherwise defined, include plural expressions. Also, throughout the specification, it should be understood that the terms “comprise”, “have”, etc. are used herein to specify the presence of stated features, numbers, steps, operations, elements, components or combinations thereof but do not preclude the presence or addition of one or more other features, numbers, steps, operations, elements, components, or combinations thereof. That is, when a specific element is referred to as being “included”, elements other than the corresponding element are not excluded, but additional elements may be included in embodiments of the present disclosure or the scope of the present disclosure.

Furthermore, some elements may not serve as necessary elements to perform an essential function in the present disclosure, but may serve as selective elements to improve performance. The present disclosure may be embodied by including only necessary elements to implement the spirit of the present disclosure excluding elements used to improve performance, and a structure including only necessary elements excluding selective elements used to improve performance is also included in the scope of the present disclosure

Hereinafter, embodiments of the present disclosure are described in detail with reference to the accompanying drawings. When determined to make the subject matter of the present disclosure unclear, the detailed description of known configurations or functions is omitted. To help with understanding with the disclosure, in the drawings, like reference numerals denote like parts, and the redundant description of like parts will not be repeated.

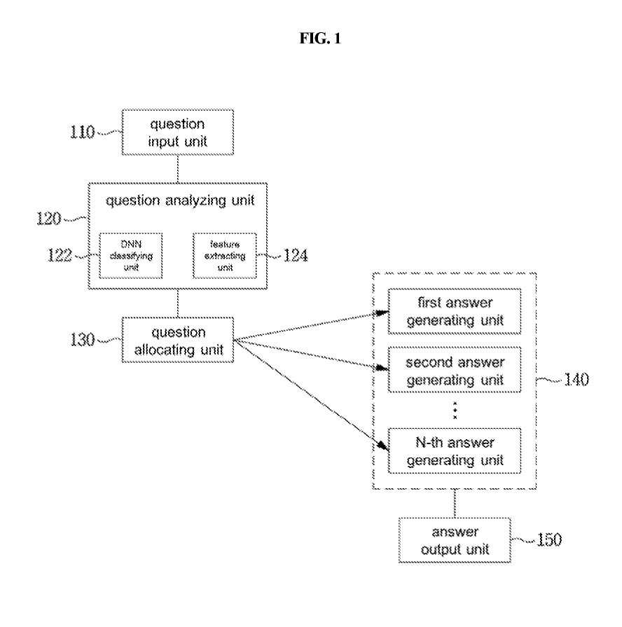

FIG. 1 is a view showing a question allocating apparatus according to an embodiment of the present disclosure.

Referring to FIG. 1, a question allocating apparatus according to the present disclosure may include a question input unit 110, a question analysis unit 120, a question allocating unit 130, an answer generating unit 140, and an answer output unit 150.

The question input unit 110 receives a conversation input from a user, and performs natural language processing for an input question. In one embodiment, when a voice of the user is input, the question input unit may transform the input voice into text (STT, speech-to-text), and perform natural language processing (NLP) so that a computer may perform transforming for processing the transformed text.

The question analysis unit 120 may apply word embedding to the result where the natural language processing is completed, and analyze a question on the basis of the word embedding result. As a result of the question analysis, at least one of question type information representing a question type, and question feature information representing a question feature may be generated.

The question analysis unit 120 may include a deep learning network (DNN) classifying unit 122 determining a question type, and a feature extracting unit 124 extracting a question feature. The DNN classifying unit 122 may determine a question type by performing at least one of question domain classification, question answer type classification, discourse type (Dialog Act) analysis, and sentiment analysis. Herein, the DNN classifying unit 122 may operate on the basis of data obtained by performing learning using a deep neural network. The feature extracting unit 124 may extract a question feature on the basis of a time, a space, a position, a named entity, etc.

In the present disclosure, a plurality of answer generating units 140 that operate on the basis of different question and answer (QA) engines may be included. The question allocating unit 130 allocates a question to the answer generating unit 140 that is suitable for generating an answer for the same on the basis of the question analysis result among a plurality of answer generating units 140. The question allocating unit 130 may allocate a question by referencing, in addition to the question analysis result, at least one of information of a user profile and information of a previous conversation record (log data). In addition, the question allocating unit 130 may allocate a question on the basis of priorities between the answer generating units 140.

The answer generating unit 140 generates an answer to an input question. The answer generating unit 140 may be operated by at least one QA engine. Herein, different QA engines may be applied among the answer generating units 140.

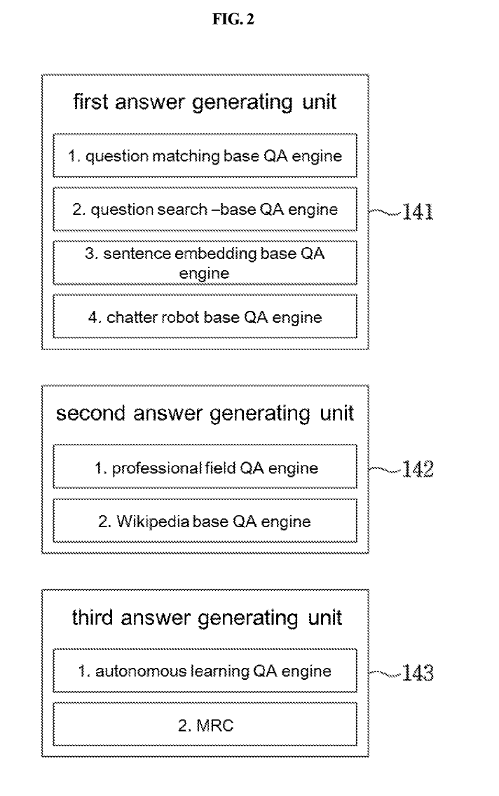

FIG. 2 is a view showing an exemplary configuration of a plurality of answer generating units.

In FIG. 2, a first answer generating unit 141, a second answer generating unit 142, and a third answer generating unit 143 are shown as an example. The first answer generating unit 141 shown in FIG. 2 generates an answer to an input question by using a question-answer database that is established in advance, and the second answer generating unit 142 generates an answer to a question corresponding to the professional knowledge field. The third answer generating unit 143 generates an answer to an input question on the basis of machine learning.

The first answer generating unit 141 may generate an answer on the basis of at least one of a question matching base QA engine, a question search base QA engine, a sentence embedding base QA engine, and a chatter robot base QA engine.

The question matching base QA engine means a QA engine that outputs an answer to a question on the basis of a database where a question and an answer are mapped. In one embodiment, the question matching base QA engine determines whether or not a question identical or similar to a question input by the user is present in a database, and when a question identical or similar to the input question is found, an answer mapping in association with the question identical or similar to the input question may be output.

The question search base QA engine means a QA engine that sets a search query on the basis of an input question, determines whether or not a question corresponding to the search query is present on the basis of the set search query, and outputs an answer in association of the found question.

Sentence embedding means that a meaning of a question is represented as a vector in a multi-dimensional space. The sentence embedding base QA engine means a QA engine that searches for a question having a vector identical or similar to an input question, and outputs an answer in association of the found question.

A chatter robot means a chat type messenger providing, by artificial intelligence (AI), an answer in an ordinary language on the basis of performing big data analysis when a question is input as performing chat in a messenger. The chatter robot base QA engine means a QA engine that generates an answer to an input question by using the chatter robot.

The second answer generating unit 142 may generate an answer on the basis of at least one of a professional field QA engine and a Wikipedia base QA engine.

The professional filed QA engine means a QA engine that generate an answer to a question of a specific field such as sport, history, medical, health, science, law, real estate, economy, etc.

The Wikipedia base QA engine means a QA engine that generates an answer to a question by using an online encyclopedia. The Wikipedia base QA engine may generate an answer to a question on the basis of triple analysis. The triple analysis may mean outputting as an answer contents included in a corresponding index when the question includes a specific theme and lower indexes. In one embodiment, the Wikipedia may be configured with indexes for a specific theme, and contents mapping to each index. In one embodiment, for a person “A”, indexes of “nationality”, “date of birth”, “achievement”, “level of education”, etc. may be configured, and contents suitable for each index (for example, “nationality”—Korean, “date of birth”—Jan. 1, 2000, etc.) may be mapped. When an input question is “nationality of A”, by the triple analysis, an answer including contents of “Korean” corresponding to the “nationality” of the person “A” may be output through the Wikipedia base QA engine.

The third answer generating unit 143 may generate an answer on the basis of at least one of an autonomous learning QA engine and machine reading comprehension (MRC).

The autonomous learning QA engine means software where knowledge is learned on the basis of a natural language, and knowledge and intelligence evolve. In one embodiment, Exobrain developed by Ministry of Science, ICT and Future Planning, Watson of the IBM Corp., AlphaGo of the Google, Tay of the MS Corp. may correspond.

MRC means that a conversation in a question and answer form is available after a machine performs leaning on the basis of a deep learning algorithm.

The answer generating unit 140 may generate an answer to a question in consideration of priorities among QA engines. In an example shown in FIG. 2, priorities among QA engines are represented in numbers. In one embodiment, the answer generating unit 140 may generate an answer to a question by using a QA engine having the highest priority, and generate an answer to a question by using a QA engine having a subsequent priority when the answer is not generated by the QA engine having high priority. In one embodiment, when a question is allocated to the first answer generating unit 141, the first answer generating unit 141, first, may determine whether or not generating an answer to the question is available on the basis of the question matching base QA engine that has the highest priority. Based on the question matching base QA engine, when generating an answer is available, the generated answer may be output. Meanwhile, based on the question matching base QA engine, when a generating an answer is not available, based on the question search base QA engine, whether or not generating an answer to the question is available may be determined.

Alternatively, the answer generating unit 140 may attempt to generate an answer to a question by using each of a plurality of QA engines, and when a plurality of answers is generated, at least one of the plurality of answers may be selected and output on the basis of priorities among QA engines. In one embodiment, when a question is allocated to the second answer generating unit 142, the second answer generating unit 142 may attempt to generate an answer on the basis of the professional field QA engine and the Wikipedia base QA engine. When a first answer is generated by using the professional field QA engine, and a second answer is generated by using the Wikipedia base QA engine, the answer generating unit 140 may output the first answer generated by using the professional field QA engine since the professional field QA engine has higher priority than the Wikipedia base QA engine.

Priorities may be set among the answer generating units 140. In one embodiment, the first answer generating unit 141 may have a priority higher than the second answer generating unit 142, and the second answer generating unit 142 may have a priority higher than the third answer generating unit 143. When a plurality of answers for a question is output by using the plurality of answer generating units 140, the answer output unit may output an answer on the basis of the answer generated by using the answer generating unit 140 having the highest priority among the plurality of answers. In one embodiment, for a specific question, when a first answer is generated by using the first answer generating unit 141, a second answer is generated by using the second answer generating unit 142, and a third answer is generated by using the third answer generating unit 143, the answer output unit 150 may output an answer on the basis of the first answer that is generated by using the first answer generating unit 141 having the highest priority.

Configuration and operation of the answer generating unit 140 shown in FIG. 2 are an example to which the present disclosure may be applied, and the present disclosure is not limited thereto. A number of answer generating units 140 which is greater than shown in FIG. 2 may be present, or less than shown in FIG. 2 may be present. In addition, a QA engine used by each answer generating unit 140 may differ from that of shown in FIG. 2. In one embodiment, the answer generating unit 140 may operate by operating at least one QA engine. However, a QA engine in association with operation of the answer generating unit 140 is not limited to examples shown in FIG. 2.

The answer output unit 150 may generate natural language in association with an answer generated by using the answer generating unit 140, and perform text-to-speech (TTS) for the same.

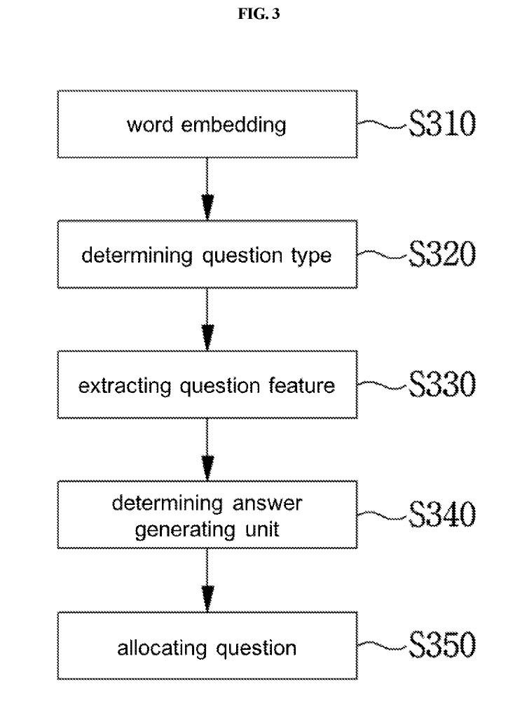

FIG. 3 is a view showing a flowchart of question analysis and question allocation according to the present disclosure. In FIG. 3, question analysis and question allocation are described in a sequence of orders. However, question analysis and question allocation may be performed in a series of orders in a sequence different from the sequence shown.

Referring to FIG. 3, first, in step S310, the question analysis unit 120 may perform word embedding for a question for which natural-language is processed. Word embedding means representing a meaning of a word included in a question as a vector in a multi-dimensional space.

In step S320, the DNN classifying unit 122 may determine a type of an input question on the basis of the word embedding result. The question type may be determined on the basis of at least one of domain classification, question answer type classification, discourse type analysis, and emotional tone analysis.

Domain classification means classifying an input question by any one of domains predefined. Herein, the domain classification may be performed on the basis of at least one of a form and contents of a question. The form of the question may mean whether the question requires an answer of “YES/NO” (Yes or No Question), whether or not the question is a short-answer question, whether or not the question requires selecting any one of a plurality of candidates (Choose Question), whether the question requires an answer of “WHY/HOW” (Why/How Question), etc. The contents of the question may mean various themes such as sport, history, entertainment, heath, etc.

Question answer type classification means determining an answer type of a question. Herein, the answer type may represent a theme related to the answer such as “city”, “height”, “people”, “time”, “weather”, etc. In one embodiment, an answer type of a question of “What city was A born in?” is determined as “city”, an answer type of a question “What is the height of Mt. BaekDu?” is determined as “height”, and an answer type of a question “Who is the first president of our country?” is determined as “people”.

Discourse type analysis means determining a type of an input question. By the discourse type analysis, at least one of question types which are a YES/NO question, a short-answer question, a select type question, a WHY/HOW question, etc. and a question purpose such as complaint, counsel, inquiry, etc. may be determined.

Emotional tone analysis means analyzing an emotional tone of a question on the basis of intonation, pitch, and size of the user's voice, question contents, endings or punctuation marks of the question. In one embodiment, by performing emotional tone analysis, emotional tones of complaints, ordinary, satisfaction etc. may be recognized.

The DNN classifying unit 122 may output information representing a question type (hereinafter, referred as “question type information”) on the basis of at least one of the domain classification result, the question answer type classification result, the discourse type analysis result, and the emotional tone analysis result. Herein, the question type information may include information representing that the question does not correspond to a predefined question type, information representing that determining a question type is not available, etc.

Then, in step S330, the feature extracting unit 124 may extract a question feature. Herein, the question feature may include a time, a space, a position (for example, place name), a named entity (for example, name of person, organization name, institution name, unit, etc.), etc. The feature extracting unit 124 may extract feature information of the question (hereinafter, referred as “question feature information”) such as time, space, position, named entity, etc. included in the question. Herein, the question feature information may include information representing that the question does not include a feature, information representing that extracting a feature of the question has been failed, etc.

In step S340, the question allocating unit 130 may determine the answer generating unit 140 that is suitable for the input question on the basis of at least one of question type information and question feature information, and in step S350, allocate the question to the determined answer generating unit 140. Herein, the determining of the answer generating unit 140 may be performed on the basis of a lookup table where relation among question type information, question feature information, and the answer generating unit 140 are mapped. In one embodiment, Table 1 below is a table showing an example of relations between the question feature information and the answer generating unit 140.

TABLE 1

| Question feature | Answer generating unit |
|---|---|
| X1 | First answer generating unit |
| X2 | |
| X3 | Second answer generating unit |
| X4 | |
| X5 | Third answer generating unit |
| X6 | |

In one embodiment, when the question includes a feature of X1 or X2, the question allocating unit 130 may allocate the question to the first answer generating unit 141, and when the question includes a feature of X2 or X3, the question allocating unit 130 may allocate the question to the second answer generating unit 142. In addition, when the question includes a feature of X5 or X6, the question allocating unit 130 may allocate the question to the third answer generating unit 143. Although it is not shown in Table 1, for a single piece of question type information or question feature information, a plurality of answer generating units 140 may be mapped.

The question allocating unit 130 may allocate the question to at least two answer generating units 140. In one embodiment, when the question includes features of X1 and X3, the question allocating unit 130 may allocate the question to the first answer generating unit 141 mapped with the X1 feature and to the second answer generating unit 142 mapped to the X3 feature. Herein, when a first answer is generated by using the first answer generating unit 141 and a second answer is generated by using the second answer generating unit 142, the answer output unit 150 may select an answer to be output on the basis of priorities of the first answer generating unit 141 and the second answer generating unit 142. In one embodiment, when the first answer generating unit 141 has a priority higher than the second answer generating unit 142, the answer output unit 150 may output an answer by using the first answer. In order to reduce time required for outputting an answer to the question, the answer output unit 150 may select an answer that is output first (or earliest?). In one embodiment, when the question is allocated to the first answer generating unit 141 and the second answer generating unit 142, the answer output unit 150 may output an answer by selecting the same that is output first between a first answer generated by using the first answer generating unit 141 and a second answer generated by using the second answer generating unit 142.

Alternatively, the question allocating unit 130 may sequentially allocate the question to at least two answer generating units 140. In one embodiment, the question allocating unit 130 may allocate the question to the first answer generating unit 141 first, and when an answer to the question is not generated by using the first answer generating unit 141, the question allocating unit 130 may allocate the question to the second answer generating unit 142.

Question allocation information representing the answer generating unit 140 suitable for the question may be used as a basis of selecting an answer by the answer output unit 150. In one embodiment, the question allocating unit 130 may output question allocate information representing a recommending answer generating unit 140 of the question on the basis of at least one of question type information, and question feature information.

In addition, the question allocating unit 130 may allocate the question to a plurality of answer generating units 140 including the recommending answer generating unit 140. When a plurality of answers is generated by the plurality of answer generating units 140, the answer output unit 150 may select an answer to the question on the basis of question allocation information. In one embodiment, it is assumed that question allocation information indicates the first answer generating unit 141, a first answer is generated by the first answer generating unit 141, and a second answer is generated by the second answer generating unit 142. Herein, the answer output unit 150 may select the first answer generated by the first answer generating unit 141 that is indicated by the question allocate information. When an answer is not generated by the answer generating unit 140 that is indicated by the question allocate information, the answer output unit 150 may select an answer to be output on the basis of priorities between answer generating units.

The question allocating unit 130 may determine the answer generating unit 140 suitable for the question by referencing, in addition to the question analysis result, at least one of user profile information and a previous conversation record. For example, when question type information represents that determining a question type is not available, or question feature information represents that extracting a question feature has been failed, the question allocating unit 130 may determine the answer generating unit 140 suitable for the question by referencing at least one of user profile information, and a previous conversation record. Herein, the user profile information may include an age, a gender, an address, a nationality, etc. of the user who has input the question. In addition, the previous conversation record may include at least one question that is previously input by the user.

In one embodiment, according to an age or a region of the user, even the same word may have other meanings, and according to an age, a region, and a nationality of the user, evaluation of the emotional tone analysis result may change based on intonation, pitch or size of the voice.

Accordingly, the question analysis unit 120 may re-evaluate question type information or question feature information on the basis of user profile information, and determine the answer generating unit 140 suitable for the question on the basis of the re-evaluated question type information or question feature information.

In one embodiment, the question allocating unit 130 may determine an answer generating unit 140 suitable for a current question on the basis of question type or feature information of a previous question. For example, when the most recent question was a question of “How is the weather in Seoul?”, and a current question is question of “How about Daejon?”, the current question may be understood to asking for “weather” as the previous question. Accordingly, the question allocating unit 130 may determine an answer generating unit 140 suitable for the current question by using question type information (“how question”) of the previous question or question feature information (“weather”) of the previous question. However, when the currently input question is input rather than the previous input question after elapsing a predetermined time, correlation between the previous input question and the currently input question is very low. Accordingly, the question allocating unit 130 may determine an answer generating unit 140 suitable for the current question by using question type information or question feature information of a question that is before elapsing a predetermined time in comparison with a current time among previously input questions. In addition, the question allocating unit 130 may determine an answer generating unit 140 suitable for the current question by using a plurality of previously input questions.

When outputting question type information or question feature information is not available or when accurately determining a question type or question feature is not available, the question allocating unit 130 may allocate the question according to priorities among the answer generating units 140. In one embodiment, when the first answer generating unit 140 has a priority higher than the second answer generating unit 140, and the second answer generating unit 140 has a priority higher than the third answer generating unit 140, the question allocating unit 130 may preferentially allocate the question to the first answer generating unit 140. When an N-th answer generating unit 140 fails to generate an answer to the question, the question allocating unit 130 may allocate the question to an N+1-th answer generating unit 140 having the sequent priority than the N-th answer generating unit 140.

Alternatively, the question generating unit may allocate the question to a plurality of answer generating units 140. Herein, the answer output unit 150 may determine an answer to be output on the basis of priorities among answer generating units 140. In one embodiment, when a first answer is generated by the first answer generating unit 140, and a second answer is generated by the second answer generating unit 140, the answer generating unit 140 may select the first answer generated by the first answer generating unit 140 having a priority higher than the second answer generating unit 140.

In order to reduce a time required for outputting an answer to the question, the answer generating unit 140 may select an answer that is output first. In one embodiment, when an answer is generated and output from any one of the first answer generating unit 140 to the third answer generating unit 140, the answer output unit 150 may output an answer by selecting the same that is output first.

Although the present disclosure has been described in terms of specific items such as detailed components as well as the limited embodiments and the drawings, they are only provided to help general understanding of the invention, and the present disclosure is not limited to the above embodiments. It will be appreciated by those skilled in the art that various modifications and changes may be made from the above description.

Therefore, the spirit of the present disclosure shall not be limited to the above-described embodiments, and the entire scope of the appended claims and their equivalents will fall within the scope and spirit of the invention.

What is claimed is:

1. An apparatus for allocating a question, the apparatus comprising:
a question analysis unit generating at least one of question type information and question feature information of a current question; and
a question allocating unit determining an answer generating unit suitable for the current question among a plurality of answer generating units based on at least one of the question type information and the question feature information, and allocating the current question to at least one answer generating including the determined answer generating unit.

2. The apparatus of claim 1, wherein the answer generating unit operates based on a plurality of QA engines, and the QA engine used for generating an answer to the current question is determined based on priorities among the plurality of QA engines.

3. The apparatus of claim 2, wherein when the answer generating unit fails to generate the answer to the current question by using a QA engine having an N-th priority, the answer generating unit generates the answer to the current question by using a QA engine having an N+1-th priority.

4. The apparatus of claim 1, further comprising an answer output unit outputting the answer generated by using the answer generating unit, wherein when a plurality of answers is generated for the current question, the answer outputting unit selects an answer to be output from the plurality of answers based on priorities among the plurality of answer generating units.

5. The apparatus of claim 1, wherein the question type information includes information of at least one of a domain to which the current question belongs, an answer type of the current question, a discourse type of the current question, and an emotional tone of the current question.

6. The apparatus of claim 1, wherein the question feature information is generate based on at least one of a time, a space, a position, and a named entity included in the current question.

7. The apparatus of claim 1, wherein the question allocating unit determines the answer generating unit in consideration of at least one of user profile information and previous conversation record data.

8. The apparatus of claim 7, wherein the previous conversation record data includes a question that is input previously than the current question, and the question allocating unit determines the answer generating unit suitable for the current question by referencing at least one of question type information and question feature information of the previous question.

9. A method of allocating a question, the method comprising:
generating at least one of question type information and question feature information of a current question;
determining an answer generating unit suitable for generating an answer to the current question from a plurality of answer generating units based on at least one of the question type information and the question information; and
allocating the current question to at least one answer generating unit including the determined answer generating unit.

10. The method of claim 9, wherein the answer generating unit operates based on a plurality of QA engines, and the QA engine used for generating an answer to the current question is determined based on priorities among the plurality of QA engines.

11. The method of claim 10, wherein when the answer generating unit fails to generate the answer to the current question by using a QA engine having an N-th priority, the answer generating unit generates the answer to the current question by using a QA engine having an N+1-th priority.

12. The method of claim 9, further comprising outputting the answer generated by the at least one answer generating unit, wherein when a plurality of answers is generated for the current question, an answer to be output is selected from the plurality of answers based on priorities among the plurality of answer generating units.

13. The method of claim 9, wherein the determining of the answer generating unit is performed in consideration of at least one of user profile information, and previous conversation record data.

14. The method of claim 13, wherein the previous conversation record data includes a question that is previously input than the current question, and the question allocating unit determines the answer generating unit suitable for the current question by referencing at least one of question type information and question feature information of the previous question.
